(19) United States
(12) Patent Application Publication
(10) Pub. No.: US 2021/0375073 A1
(43) Pub. Date: Dec. 2, 2021

(54) SERVER DEVICE, CONTROL DEVICE, VEHICLE, AND OPERATION METHOD FOR INFORMATION PROCESSING SYSTEM

(71) Applicant: Toyota Jidosha Kabushiki Kaisha, Toyota-shi Aichi-ken (JP)

(72) Inventors: Tsuyoshi Andou, Toyota-shi (JP); Akitoshi Jikumaru, Nisshin-shi (JP); Ryosuke Kobayashi, Nagakute-shi (JP); Tomokazu Maya, Nagoya-shi (JP); Masatoshi Hayashi, Nisshin-shi (JP)

(73) Assignee: Toyota Jidosha Kabushiki Kaisha, Toyota-shi Aichi-ken (JP)

(21) Appl. No.: 17/229,336

(22) Filed: Apr. 13, 2021

(30) Foreign Application Priority Data
May 29, 2020 (JP) 2020-094756

(51) Int. Cl. G07C 5/00; G06K 9/00; G01C 21/36; B60R 16/023; G01C 21/28

(52) U.S. Cl. CPC G07C 5/008; G06K 9/00791; G06K 9/00832; B60R 16/0232; G01C 21/28; G01C 21/3602

(57) ABSTRACT

The server device includes a communication unit and a control unit that sends and receives information to and from another device via the communication unit. The control unit sends a captured image of surroundings of a vehicle or an inside of a vehicle cabin when a traveling mode of the vehicle is different from a past traveling mode to a terminal device such that the terminal device outputs the captured image.

### CROSS-REFERENCE TO RELATED APPLICATION

This application claims priority to Japanese Patent Application No. 2020-094756 filed on May 29, 2020, incorporated herein by reference in its entirety.

### BACKGROUND

### 1. Technical Field

The present disclosure relates to a server device, a control device, a vehicle, and an operation method for an information processing system.

### 2. Description of Related Art

Technologies that support the prevention of dangerous driving of vehicles are known. For example, Japanese Unexamined Patent Application Publication No. 2015-219736 (JP 2015-219736 A) discloses a system that predicts dangerous driving based on the position of a vehicle and encourages the driver to drive safely.

### SUMMARY

There is room for improvement in techniques for determining dangerous driving and other improper driving.

In the following, a server device and the like will be disclosed that can improve the determination of improper driving.

A server device according to the present disclosure includes a communication unit and a control unit that sends and receives information to and from another device via the communication unit. The control unit sends a captured image of surroundings of a vehicle or an inside of a vehicle cabin when a traveling mode of the vehicle is different from a past traveling mode to a terminal device such that the terminal device outputs the captured image.

A control device for a vehicle according to the present disclosure includes a communication unit and a control unit that sends and receives information to and from another device via the communication unit. The control unit sends a captured image of surroundings of a vehicle or an inside of a vehicle cabin when a traveling mode of the vehicle is different from a past traveling mode to a server device such that the server device sends the captured image to the terminal device.

In an operation method for an information processing system according to the present disclosure, the information processing system including a server device and a vehicle that send and receive information to and from each other, the vehicle sends a captured image of surroundings of the vehicle or an inside of a vehicle cabin when a traveling mode of the vehicle is different from a past traveling mode to the server device, and the server device sends the captured image to the terminal device such that the terminal device outputs the captured image.

With the server device and the like according to the present disclosure, it is possible to improve the determination of improper driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an information processing system;

FIG. 2 is a diagram showing a configuration example of a server device;

FIG. 3 is a diagram showing a configuration example of a terminal device;

FIG. 4 is a diagram showing a configuration example of a vehicle;

FIG. 5 is a sequence diagram showing an operation example of an information processing system;

FIG. 6 is a diagram showing an example of information stored in a storage unit;

FIG. 7 is a flowchart showing an operation example of the server device;

FIG. 8 is a diagram showing an output example of the terminal device; and

FIG. 9 is a sequence diagram showing an operation example of the information processing system.

### DETAILED DESCRIPTION OF EMBODIMENTS

Hereinafter, embodiments will be described.

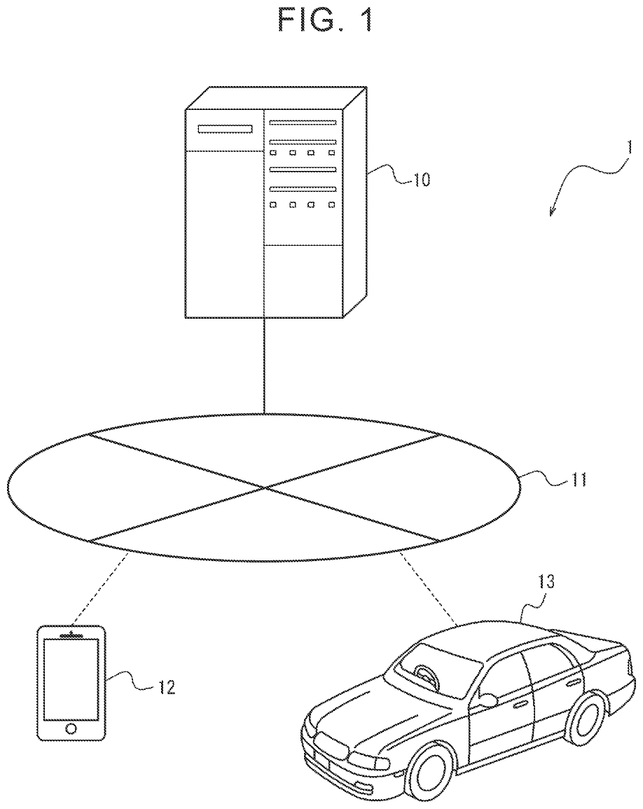

FIG. 1 is a diagram showing a configuration example of an information processing system according to an embodiment. The information processing system 1 includes, for example, a server device 10, a terminal device 12, and a vehicle 13 that are connected to each other via a network 11 so as to be able to communicate with each other. The server device 10 is a computer. The terminal device 12 is, for example, a portable information terminal device such as a smartphone or a tablet terminal device, but may be a personal computer. The vehicle 13 is a passenger car, a multipurpose vehicle, or the like having a control/communication function. The network 11 is, for example, the Internet, but includes an ad hoc network, a local area network (LAN), a metropolitan area network (MAN), another network, or a combination thereof. The number of components of the information processing system 1 may be larger than that shown here.

A driver of the vehicle 13 has his/her own driving behavior tendency. The driving behavior tendency is of interest, for example, when assessing automobile insurance, or when evaluating the performance of a driver in the case where the vehicle 13 is a taxi vehicle. Specifically, it is required to determine whether the driving behavior tendency is oriented toward safe and proper driving (hereinafter collectively referred to as proper driving) or dangerous or improper driving (hereinafter collectively referred to as improper driving). Here, since the driving behavior tendency is reflected in a traveling mode of the vehicle 13, it is possible to determine the driving behavior tendency of the driver using information regarding the traveling mode of the vehicle 13. However, if a driver who normally encourages proper driving happens to exhibit improper driving for some reason, it is necessary to identify the factor that induced such driving in order to understand the driver's original tendency. The information processing system 1 in the present embodiment supports the identification of the factor that induced the improper driving, and thereby contributes to the improvement of the determination of improper driving.

In the present embodiment, the vehicle 13 sends a captured image of surroundings of the vehicle 13 when the traveling mode of the vehicle 13 is different from the past traveling mode to the server device 10. The traveling mode includes, for example, an acceleration/deceleration, a rate of change in steering angle over time, a selected route, and the like. The traveling mode corresponds to a driver's driving behavior such as depression/release of an accelerator pedal, steering, braking operation, and route selection. The past traveling mode corresponds to a normal driving behavior of the driver of the vehicle 13 and reflects the tendency of the driver. Therefore, when the traveling mode of the vehicle 13 is different from the past traveling mode, it is highly probable that the driver has performed a driving behavior different from the original tendency for some reason. The server device 10 sends a captured image of the surroundings of the vehicle 13 to the terminal device 12 such that the terminal device 12 outputs the captured image. Therefore, for example, when the driver or the person in charge of assessing the automobile insurance verifies the captured image output by the terminal device 12, it is possible to identify the factor that induced the driver's improper driving. Examples of the factor that induces improper driving such as sudden braking or sudden steering include a road obstacle or jumping out of a pedestrian that must be avoided by sudden braking or sudden steering. Further, examples of the factor that induces improper driving such as sudden acceleration include chasing by another vehicle from behind, road rage, etc., which must be avoided by sudden acceleration, or coercion and intimidation by a passenger when the vehicle 13 is a taxi vehicle. Alternatively, examples of the factors of improper driving such as adopting a route different from the usual route include congestion and road closure on the normal route. As described above, according to the information processing system 1, it is possible to improve the determination of improper driving.

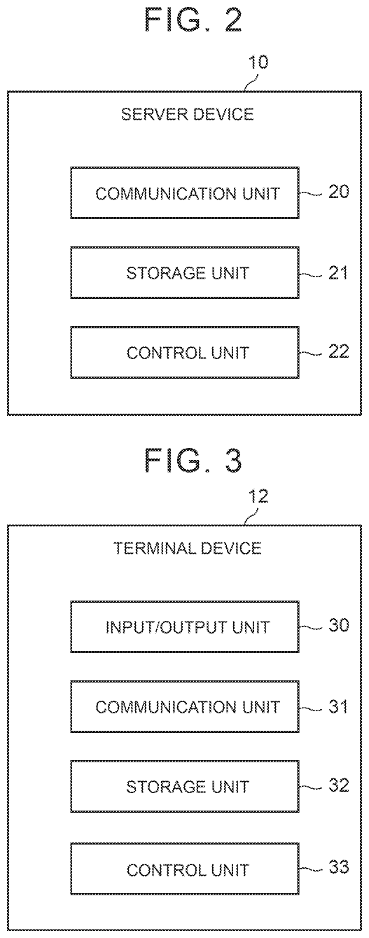

FIG. 2 shows a configuration example of the server device 10. The server device 10 has a communication unit 20, a storage unit 21, and a control unit 22. The server device 10 may perform the operation according to the present embodiment by communicating with and cooperating with another server device having an equivalent configuration.

The communication unit 20 has one or more communication modules corresponding to a wired or wireless LAN standard for connecting to the network 11. In the present embodiment, the server device 10 is connected to the network 11 via the communication unit 20, and performs information communication with another device via the network 11.

The storage unit 21 has, for example, a semiconductor memory, a magnetic memory, an optical memory, or the like. The storage unit 21 functions as, for example, a main storage device, an auxiliary storage device, or a cache memory. The storage unit 21 stores information, a control/processing program, and the like used for the operation of the server device 10.

The control unit 22 has, for example, one or more general-purpose processors such as a central processing unit (CPU), or one or more dedicated processors specialized for a specific process. Alternatively, the control unit 22 may have one or more dedicated circuits such as a field-programmable gate array (FPGA) and an application specific integrated circuit (ASIC). The control unit 22 comprehensively controls the operation of the server device 10 by operating according to the control/processing program or operating according to an operation procedure implemented as a circuit. Then, the control unit 22 sends and receives various information to and from the terminal device 12 and the vehicle 13 via the communication unit 20, and performs the operation according to the present embodiment.

FIG. 3 shows a configuration example of the terminal device 12. The terminal device 12 is an information terminal device such as a smartphone, a tablet terminal device, or a personal computer. The terminal device 12 has an input/output unit 30, a communication unit 31, a storage unit 32, and a control unit 33.

The input/output unit 30 has an input interface that detects the user's input and sends the input information to the control unit 33. The input interface is any input interface including, for example, a physical key, a capacitive key, a touch screen integrated with a panel display, various pointing devices, a microphone that accepts voice input, a camera that captures a captured image or an image code, and the like. Further, the input/output unit 30 has an output interface that outputs, to the user, information generated by the control unit 33 or received from another device. The output interface is any output interface including, for example, an external or built-in display that outputs information as an image/video, a speaker that outputs information as audio, or a connection interface for an external output device.

The communication unit 31 has a communication module corresponding to a wired or wireless LAN standard, a module corresponding to a mobile communication standards such as fourth generation (4G) and fifth generation (5G), and the like. The terminal device 12 is connected to the network 11 through the communication unit 31 via a nearby router device or a mobile communication base station, and performs information communication with other devices via the network 11.

The storage unit 32 has, for example, a semiconductor memory, a magnetic memory, an optical memory, or the like. The storage unit 32 functions as, for example, a main storage device, an auxiliary storage device, or a cache memory. The storage unit 32 stores information, a control/processing program, and the like used for the operation of the terminal device 12.

The control unit 33 has, for example, one or more general-purpose processors such as a CPU, a micro processing unit (MPU), or one or more dedicated processors specialized for a specific process. Alternatively, the control unit 33 may have one or more dedicated circuits such as an FPGA and an ASIC. The control unit 33 comprehensively controls the operation of the terminal device 12 by operating according to the control/processing program or operating according to an operation procedure implemented as a circuit. Then, the control unit 33 sends and receives various information to and from the server device 10 and the like via the communication unit 31, and performs the operation according to the present embodiment.

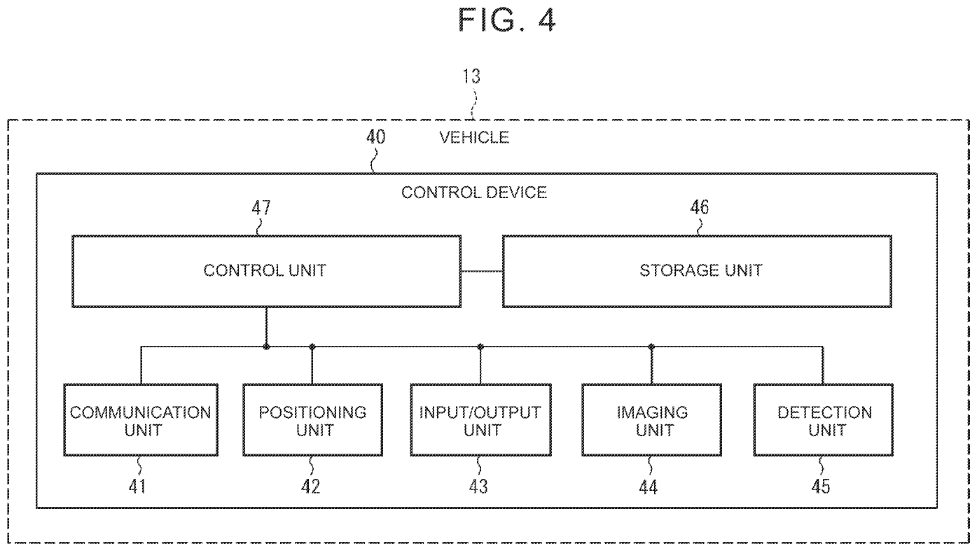

FIG. 4 shows a configuration example of the control device 40 mounted on the vehicle 13. The control device 40 includes a communication unit 41, a positioning unit 42, an input/output unit 43, an imaging unit 44, a detection unit 45, a storage unit 46, and a control unit 47. The control device 40 is, for example, a navigation device, a mobile phone, a smartphone, a tablet, or a personal computer (PC). The vehicle 13 may be driven by the driver, or the driving may be automated at a desired level. The level of automation is, for example, one of level 1 to level 5 in the Society of Automotive Engineers (SAE) leveling.

The communication unit 41 includes one or more communication interfaces. The communication interface is, for example, an interface compatible with mobile communication standards such as a long term evolution (LTE), 4G, or 5G. The communication unit 41 receives the information used for the operation of the control device 40, and sends the information obtained through the operation of the control device 40. The control device 40 is connected to the network 11 through the communication unit 41 via a mobile communication base station, and performs information communication with other devices via the network 11.

The positioning unit 42 includes one or more global navigation satellite system (GNSS) receivers. The GNSS includes, for example, at least one of a global positioning system (GPS), a quasi-zenith satellite system (QZSS), a global navigation satellite system (GLONASS), and Galileo. The positioning unit 42 acquires position information of the vehicle 13.

The input/output unit 43 includes one or more input interfaces and one or more output interfaces. The input interface is, for example, a physical key, a capacitive key, a pointing device, a touch screen integrated with a display, or a microphone that accepts voice input. The output interface is, for example, a display or a speaker. The display is, for example, a liquid crystal display (LCD) or an organic electro luminescence (EL) display. The input/output unit 43 accepts an operation of inputting information used for the operation of the control device 40, sends the input information to the control unit 47, and outputs information obtained through the operation of the control device 40.

The imaging unit 44 includes one or more cameras and a control circuit therefor, which are provided at positions that enables imaging of the surroundings of the vehicle 13 or the inside of the vehicle cabin. The camera of the imaging unit 44 may be a monocular camera or a stereo camera. The imaging unit 44 images the surroundings of the vehicle 13 or the inside of the vehicle cabin at predetermined time intervals, and sends the captured images to the control unit 47. Further, the captured images may be associated with information on audio around the vehicle 13 or inside the vehicle cabin, which is acquired from the input interface of the input/output unit 43.

The detection unit 45 has sensors for detecting the motion state of the vehicle 13. The sensors include, for example, sensors that detect a vehicle speed, an acceleration, a steering angle, a tilt, a braking operation, and the like of the vehicle 13. The detection unit 45 detects information indicating the motion state of the vehicle 13 by the sensors and sends the information to the control unit 47.

The storage unit 46 includes one or more semiconductor memories, one or more magnetic memories, one or more optical memories, or a combination of at least two of them. The semiconductor memory is, for example, a random access memory (RAM) or a read only memory (ROM). The RAM is, for example, a static RAM (SRAM) or a dynamic RAM (DRAM). The ROM is, for example, an electrically erasable ROM (EEPROM). The storage unit 46 functions as, for example, a main storage device, an auxiliary storage device, or a cache memory. The storage unit 46 stores the information used for the operation of the control device 40 and the information obtained through the operation of the control device 40.

The control unit 47 has one or more general-purpose processors such as a CPU and an MPU, or one or more dedicated processors specialized for a specific process. Alternatively, the control unit 47 may have one or more dedicated circuits such as an FPGA and an ASIC. The control unit 47 comprehensively controls the operations of the control device 40 and the vehicle 13 by operating according to a control/processing program or operating according to an operation procedure implemented as a circuit. The control unit 47 sends and receives various information to and from the server device 10 via the communication unit 41, and performs the operation according to the present embodiment.

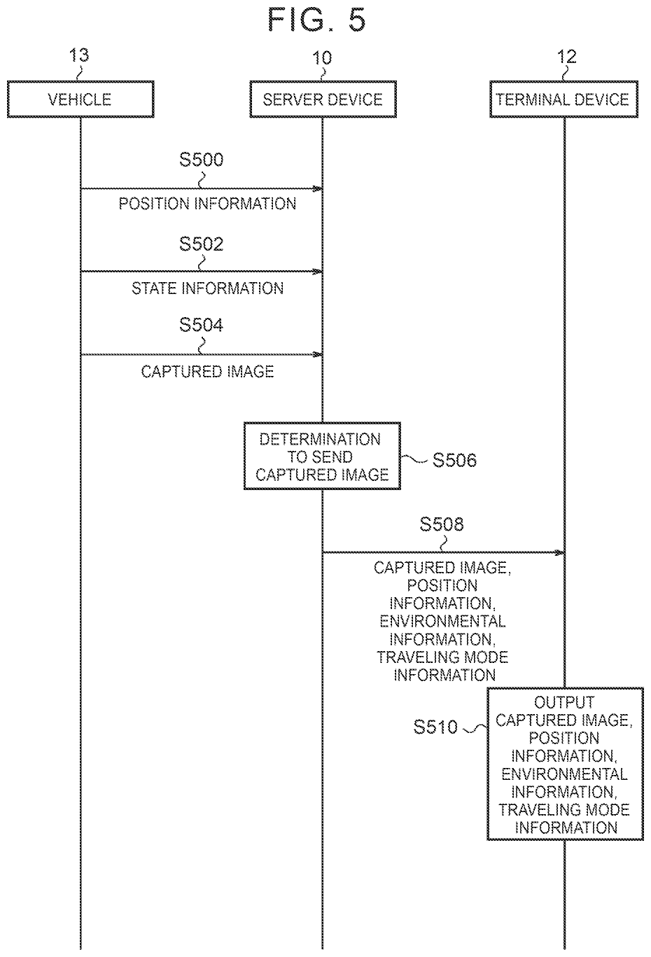

FIG. 5 is a sequence diagram showing an operation example of the information processing system 1. FIG. 5 shows an operation procedure of the cooperative operation by the server device 10, the terminal device 12, and the vehicle 13. The procedure of FIG. 5 is performed from during running of the vehicle 13 to after the running.

In step S500, the vehicle 13 sends the position information to the server device 10. The control unit 47 of the vehicle 13 sends the current position of the vehicle 13 acquired from the positioning unit 42 to the server device 10 via the communication unit 41. The control unit 22 of the server device 10 receives the position information via the communication unit 20 and stores it in the storage unit 21. Step S500 is repeated at predetermined time intervals (e.g., intervals of a few milliseconds to a few seconds).

In step S502, the vehicle 13 sends state information indicating the motion state of the vehicle 13 to the server device 10. The state information is, for example, information indicating the motion state such as the vehicle speed, the acceleration, and the steering angle of the vehicle 13 detected by the detection unit 45 of the vehicle 13. The control unit 47 of the vehicle 13 sends the state information to the server device 10 via the communication unit 41. The control unit 22 of the server device 10 receives the state information via the communication unit 20 and stores it in the storage unit 21.

In step S504, the vehicle 13 sends the captured image to the server device 10. The control unit 47 of the vehicle 13 sends the captured image of the surroundings of the vehicle 13 or the inside of the vehicle cabin, which is captured by the imaging unit 44, to the server device 10 via the communication unit 41. The control unit 22 of the server device 10 receives the captured image via the communication unit 20. Step S504 is repeated at predetermined time intervals (e.g., intervals of a few milliseconds to a few seconds).

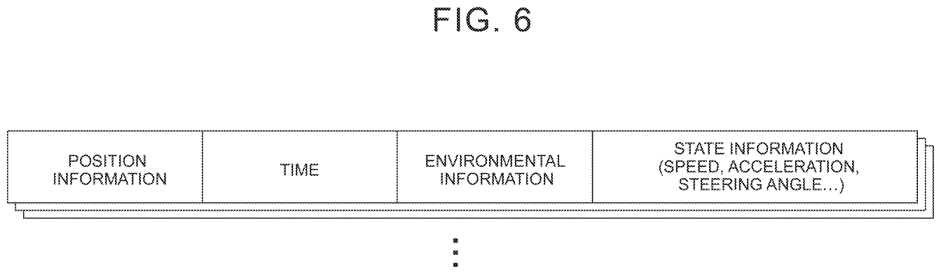

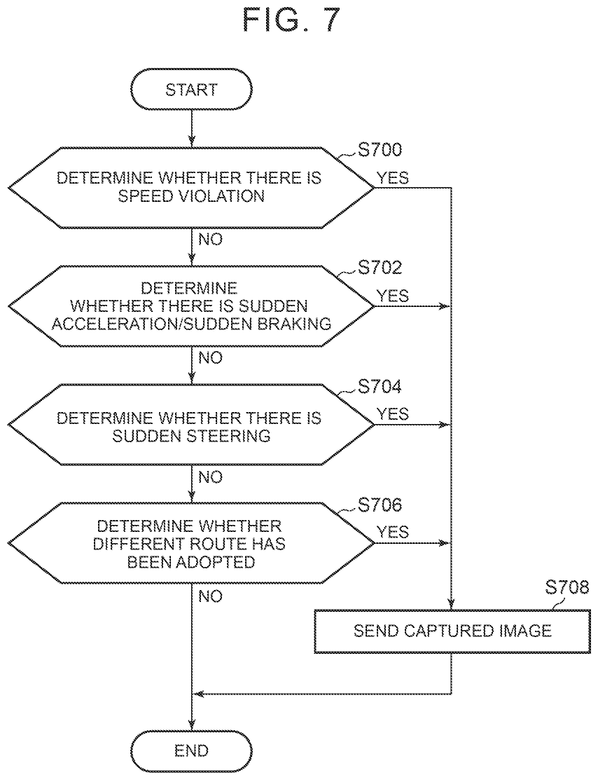

In step S506, the server device 10 determines whether to send the captured image, the position information, and the like to the terminal device 12, based on the traveling mode of the vehicle 13. For example, the control unit 22 of the server device 10 compares the traveling mode corresponding to the position information and the state information of the vehicle 13 with the past traveling mode corresponding to the past position information and the past state information stored in the storage unit 21. Then, the control unit 22 determines whether the current traveling mode is different from the past traveling mode. When the current traveling mode is different from the past traveling mode, the control unit 22 determines to send the captured image and the position information to the terminal device 12. Here, the details of step S506 will be described with reference to FIGS. 6 and 7.

FIG. 6 schematically shows the position information and the state information of the vehicle 13 stored in the storage unit 21. For example, the storage unit 21 stores the position information, the time, the environmental information, and the state information of the vehicle 13 periodically collected with the movement of the vehicle 13. Such information is stored associated with each vehicle 13. The position information and the time indicate the position of the vehicle 13 and the time when the position information is sent from the vehicle 13 to the server device 10. The time may be attached to the position information by the control unit 47 of the vehicle 13 as a time stamp, or the control unit 22 of the server device 10 may acquire the time when receiving the position information, using its timekeeping function. The environmental information indicates the environmental attribute of the point corresponding to the position of the vehicle 13 that is acquired from the map information stored in advance in the storage unit 21. For example, the environmental information includes the width of the road on which the vehicle 13 travels, the presence/absence of a corner, the presence/absence of an oncoming lane, the presence/absence of an obstacle on the road, the presence/absence of a sidewalk/pedestrian crossing, good/bad visibility, and the like. Alternatively, the environmental information may include road traffic information acquired from another server device or the like. The state information includes the vehicle speed, the acceleration, the steering angle, etc. of the vehicle 13. The control unit 22 additionally stores the newly acquired position information and the state information of the vehicle 13 in the storage unit 21 each time the step S506 is performed.

FIG. 7 is a flowchart showing a detailed procedure of the process in step S506 performed by the control unit 22 of the server device 10.

In step S700, the control unit 22 determines whether there is a speed violation. For example, the control unit 22 compares the past vehicle speed stored in the storage unit 21 with the acquired current vehicle speed of the vehicle 13. When the current vehicle speed shows an abnormal value, the control unit 22 determines there is a speed violation. Any determined criteria can be used for determination of the abnormal value. For example, a standard is set for the magnitude of a deviation from the past average value or the median value. When the magnitude of the deviation exceeds the standard, it can be determined as an abnormal value, and when the magnitude of the deviation is equal to or less than the standard, it can be determined as a normal value. The magnitude of the deviation may be an absolute value or a deviation value. The determination of the abnormal value is the same in the following description. When the control unit 22 determines there is a speed violation (Yes in step S700), that is, when the traveling mode of the vehicle 13 is different from the past traveling mode, the process proceeds to step S708, and the control unit 22 determines to send the captured image received from the vehicle 13 to the terminal device 12. When the control unit 22 does not determine that there is a speed violation (No in step S700), the control unit 22 proceeds to step S702.

In step S702, the control unit 22 determines whether there is a sudden acceleration or a sudden braking. For example, the control unit 22 compares the absolute value of the past acceleration stored in the storage unit 21 with the absolute value of the acquired current acceleration of the vehicle 13. When the current absolute value indicates an abnormal value, the control unit 22 determines that there is a sudden acceleration or a sudden braking. When the control unit 22 determines there is a sudden acceleration or a sudden braking (Yes in step S702), that is, when the traveling mode of the vehicle 13 is different from the past traveling mode, the process proceeds to step S708, and the control unit 22 determines to send the captured image received from the vehicle 13 to the terminal device 12. When the control unit 22 does not determine that there is a sudden acceleration or a sudden braking (No in step S702), the control unit 22 proceeds to step S704.

In step S704, the control unit 22 determines whether there is a sudden steering. For example, the control unit 22 obtains the rate of change over time of the acquired current steering angle with respect to the latest steering angle stored in the storage unit 21. Then, the control unit 22 compares the rate of change over time of the current steering angle with the rate of change over time of the past steering angle for the same unit time. When the rate of change over time of the current steering angle shows an abnormal value, the control unit 22 determines that there is a sudden steering. When the control unit 22 determines there is a sudden steering (Yes in step S704), that is, when the traveling mode of the vehicle 13 is different from the past traveling mode, the process proceeds to step S708, and the control unit 22 determines to send the captured image received from the vehicle 13 to the terminal device 12. When the control unit 22 does not determine that there is a sudden steering (No in step S704), the control unit 22 proceeds to step S706.

In step S706, the control unit 22 determines whether a different route has been adopted. For example, the control unit 22 derives a road on which the vehicle 13 frequently travels from the history of transitions of position information stored in the storage unit 21. For example, the control unit 22 derives the fact that the vehicle 13 frequently travels on main roads, bypasses, highways, and the like. Further, the control unit 22 derives the current traveling route of the vehicle 13 based on the transition of the acquired position information from the latest position information. When the current route deviates from the past route, the control unit 22 determines that a different route has been adopted. For example, the control unit 22 determines that the different road has been adopted when a travel distance over which the current route has deviated from the past route is larger than a predetermined reference distance, and does not determine that the different route has been adopted when the travel distance is equal to or less than or the reference distance. Examples of the case where it is determined that the difference route has been adopted include a case where the vehicle 13 frequently traveled on main roads, bypasses, highways, and the like in the past, but is now traveling through residential areas or narrow alleys. When the control unit 22 determines that the different road has been adopted (Yes in step S706), that is, when the traveling mode of the vehicle 13 is different from the past traveling mode, the process proceeds to step S708, and the control unit 22 determines to send the captured image received from the vehicle 13 to the terminal device 12. When the control unit 22 does not determine that the different road has been adopted (No in step S706), the control unit 22 ends the procedure of FIG. 7.

In step S700 or S706, the control unit 22 may perform the determination process in consideration of the environmental information. For example, in step S700, when the environmental information indicates that the vehicle 13 is traveling on a main road, the criterion for determining that there is an abnormal value is set relatively loosely at a predetermined ratio, and when the environmental information indicates that the vehicle 13 is traveling through the residential area, the criterion for determining that there is an abnormal value is set relatively strictly. This enables a suitable determination of speed violation considering the environment. Further, in step S706, when the environmental information indicates congestion or road closure in the past route of the vehicle 13, the criterion for determining that there is an abnormal value is set relatively loosely, which enables a suitable determination of the different road considering the environment.

Further, in steps S700 to S706, the control unit 22 may perform the determination process in consideration of the position information or the time. For example, the control unit 22 compares the past traveling mode with the current traveling mode at the same position as the current position of the vehicle 13. Alternatively, the control unit 22 compares the past traveling mode with the current traveling mode at the same time of day as the current time. By doing so, it is possible to eliminate the peculiarity caused by the position or the time and determine the traveling mode different from the past traveling mode.

In FIG. 5, when the server device 10 determines in step S506 to send the position information and the captured image, in step S508, the server device 10 sends the captured image, the position information, the environmental information, and the traveling mode information when the traveling mode of the vehicle 13 is different from the past traveling mode to the terminal device 12. The control unit 22 of the server device 10 sends the captured image, the position information, the environmental information, and the traveling mode information indicating the traveling mode that have been stored in the storage unit 21, to the terminal device 12 via the communication unit 20. The traveling mode information is, for example, information indicating a speed violation, a sudden acceleration/sudden braking, a sudden steering, and a different route corresponding to the determination results in steps S700 to S706, respectively, in FIG. 7. The control unit 33 of the terminal device 12 receives the captured image, the position information, the environmental information, and the traveling mode information via the communication unit 31 and stores them in the storage unit 32.

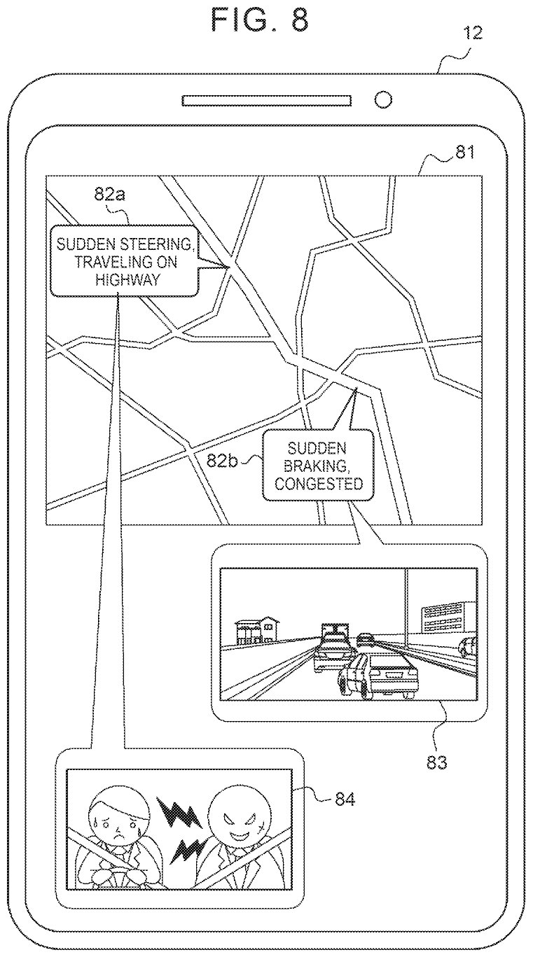

After the traveling of the vehicle 13 is completed, the terminal device 12 outputs the captured image, the position information, the environmental information, and the traveling mode information of the vehicle 13 in step S510. For example, after the traveling of the vehicle 13 is completed, step S510 is performed when evaluating the driving behavior tendency of the driver. For example, in response to the operation input of the driver or the evaluator, the control unit 33 of the terminal device 12 outputs the captured image, the position information, the environmental information, and the traveling mode information through the input/output unit 30. For example, as shown in FIG. 8, the terminal device 12 displays indications 82a, 82b indicating the traveling mode information and the environmental information in association with the position information mapped on a map 81 on a display screen 80. For example, the indication 82a includes the environmental information indicating that the vehicle is traveling on a bypass and the traveling mode information indicating a sudden steering. The indication 82b includes the environmental information indicating that there is a traffic congestion and the traveling mode information indicating a sudden braking. Further, the terminal device 12 displays captured images 83, 84 corresponding to the indications 82a, 82b, respectively, in response to, for example, a tap operation on the indications 82a, 82b. For example, the captured image 83 of another vehicle that suddenly interrupts from the side is displayed in response to a sudden braking, or the captured image 84 of a passenger forcing a sudden change of course is displayed in response to a sudden steering.

The terminal device 12 presents to the driver or the evaluator the position information, the environmental information, and the captured image obtained when the vehicle 13 presents an unusual traveling mode, which indicates that the probability of improper driving is high. Thus, the driver or the evaluator can visually verify, from the captured image, whether there is a factor that induces improper driving. At the same time, shapes, arrangement, etc. of the roads can be grasped from the position information, and the road environment, the traffic conditions, etc. can be grasped from the environmental information, which can be utilized for verification/determination of improper driving.

In the procedure of FIG. 5, step S508 may be performed each time the control unit 22 of the server device 10 detects a traveling mode different from the past traveling mode of the vehicle 13, or may be performed once after the traveling of the vehicle 13 is completed, for example. The captured image and the position information are stored in the storage unit 21 each time the control unit 22 detects a traveling mode different from the past traveling mode. One or more captured images etc. stored in the storage unit 21 may be sent to the terminal device 12, when the terminal device 12 requests the server device 10 for the captured image etc. in response to the input of the driver or the evaluator to the terminal device 12.

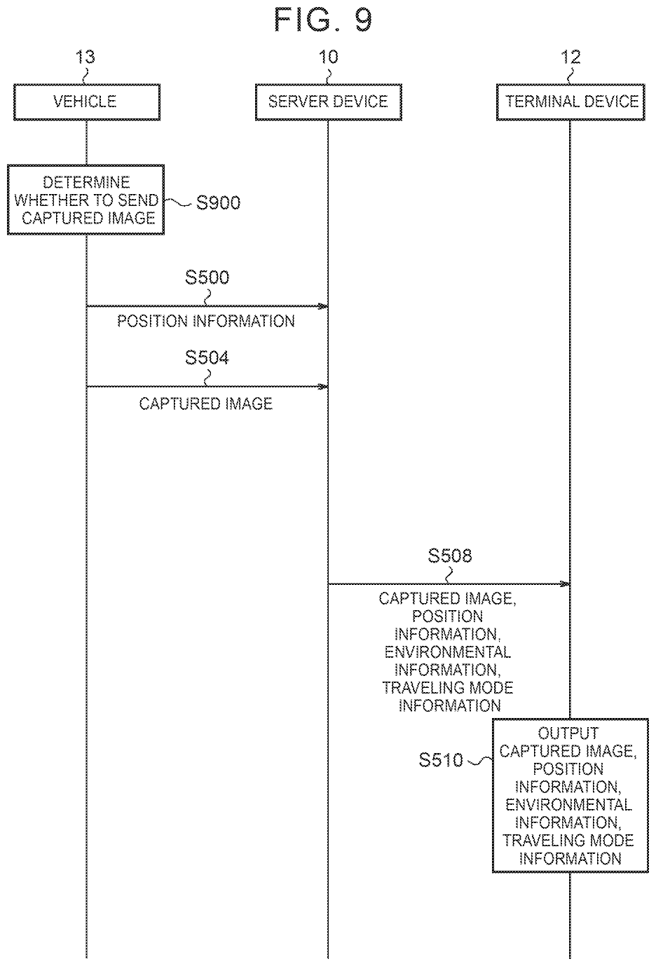

FIG. 9 shows a procedure in a modification of the present embodiment. The procedure of FIG. 9 is different from that of FIG. 5 in that step S900 is performed instead of step S506 in FIG. 5 and step S502 is omitted. The other steps are the same as those in FIG. 5.

In step S900, before the control device 40 of the vehicle 13 sends the captured image and the position information to the server device 10, the control device 40 determines whether to send the captured image, the position information, etc. to the terminal device 12 via the server device 10 based on the traveling mode of the vehicle 13. For example, the control unit 47 of the control device 40 compares the traveling mode corresponding to the position information and the state information of the vehicle 13 with the past traveling mode corresponding to the past position information and the past state information stored in the storage unit 46. Then, the control unit 47 determines whether the current traveling mode is different from the past traveling mode. When the current traveling mode is different from the past traveling mode, the control unit 47 determines to send the captured image and the position information to the terminal device 12. When the control unit 47 determines to send the captured image and the position information to the terminal device 12, the position information and the captured image are sent to the server device 10. Further, for example, the control device 40 of the vehicle 13 may be configured so that the information shown in FIG. 6 is stored in the storage unit 46, and the environmental information may be sent from the vehicle 13 to the server device 10 in addition to the position information and the captured image. According to such a modification, since the processing load of the server device 10 is distributed in the vehicle 13, the processing load of the server device 10 can be reduced.

As described above, according to the present embodiment, it is possible to improve the determination of improper driving.

In the above-described embodiment, the processing/control program defining the operation of the terminal device 12 and the control device 40 may be stored in the storage unit 21 of the server device 10 or a storage unit of another server device, and downloaded to each device via the network 11. Alternatively, the processing/control program may be stored in a portable, non-transitory recording/storage medium that can be read by each device, and may be read from the medium by each device.

Although the embodiments have been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each step, etc. can be rearranged so as not to be logically inconsistent, and a plurality of steps, etc. can be combined into one or divided.

What is claimed is:

1. A server device, comprising:
a communication unit; and
a control unit that sends and receives information to and from another device via the communication unit, wherein the control unit sends a captured image of surroundings of a vehicle or an inside of a vehicle cabin when a traveling mode of the vehicle is different from a past traveling mode to a terminal device such that the terminal device outputs the captured image.

2. The server device according to claim 1, wherein the control unit sends position information indicating a position of the vehicle when the traveling mode of the vehicle is different from the past traveling mode to the terminal device.

3. The server device according to claim 1, wherein the traveling mode includes a motion state of the vehicle.

4. The server device according to claim 1, wherein the traveling mode includes a route of the vehicle.

5. The server device according to claim 2, wherein whether the traveling mode of the vehicle is different from the past traveling mode is determined in consideration of environmental information indicating an environmental attribute of a point corresponding to the position of the vehicle.

6. The server device according to claim 5, wherein the control unit sends the environmental information to the terminal device.

7. An information processing system comprising the server device according to claim 1 and a vehicle.

8. A control device for a vehicle, the control device comprising a communication unit and a control unit that sends and receives information to and from another device via the communication unit, wherein the control unit sends a captured image of surroundings of the vehicle or an inside of a vehicle cabin when a traveling mode of the vehicle is different from a past traveling mode to a server device such that the server device sends the captured image to a terminal device.

9. The control device according to claim 8, wherein the control unit sends position information indicating a position of the vehicle when the traveling mode of the vehicle is different from the past traveling mode to the server device such that the server device sends the position information to the terminal device.

10. The control device according to claim 8, wherein the traveling mode includes a motion state of the vehicle.

11. The control device according to claim 8, wherein the traveling mode includes a route of the vehicle.

12. The control device according to claim 8, wherein whether the traveling mode of the vehicle is different from the past traveling mode is determined in consideration of environmental information indicating an environmental attribute of a point corresponding to a position of the vehicle.

13. The control device according to claim 12, wherein the control unit sends the environmental information to the server device such that the server device sends the environmental information to the terminal device.

14. A vehicle comprising the control device according to claim 8.

15. An operation method for an information processing system including a server device and a vehicle that send and receive information to and from each other, wherein:
the vehicle sends a captured image of surroundings of the vehicle or an inside of a vehicle cabin when a traveling mode of the vehicle is different from a past traveling mode to the server device; and
the server device sends the captured image to a terminal device such that the terminal device outputs the captured image.

16. The operation method according to claim 15, wherein:
the vehicle sends position information indicating a position of the vehicle when the traveling mode of the vehicle is different from the past traveling mode to the server device; and
the server device sends the position information to the terminal device.

17. The operation method according to claim 15, wherein the traveling mode includes a motion state of the vehicle.

18. The operation method according to claim 15, wherein the traveling mode includes a traveling route of the vehicle.

19. The operation method according to claim 16, wherein the server device or the vehicle determines whether the traveling mode of the vehicle is different from the past traveling mode in consideration of environmental information indicating an environmental attribute of a point corresponding to the position of the vehicle.

20. The operation method according to claim 19, wherein the server device sends the environmental information to the terminal device.
